(19) United States
(12) Patent Application Publication
(10) Pub. No.: US 2004/0258363 A1
(43) Pub. Date: Dec. 23, 2004

(54) Optical fixed attenuator and manufactuing process thereof

(75) Inventors: Masayoshi Shigihara, Tokyo (JP); Mitsuhiro Yoshida, Tokyo (JP); Etsuji Sugita, Tokyo (JP); Shuichiro Inagaki, Tokyo (JP)

Correspondence Address: McDERMOTT, WILL & EMERY, 600 13th Street, N.W., Washington, DC, 20005-3096, US

(73) Assignee: SMK CORPORATION

(21) Appl. No.: 10/868,762

(22) Filed: Jun. 17, 2004

(30) Foreign Application Priority Data
Jun. 17, 2003 (JP) 2003-172222

(51) Int. Cl. G02B 6/00

(52) U.S. Cl. 385/73; 385/140

(57) ABSTRACT

The object of the present invention is to provide a highly reliable optical fixed attenuator and the manufacturing process thereof being free of the conventional cumbersome processes including the process for inserting the optical fiber into the ferrule and fixing thereto. In the present invention, the surface of an optical fiber is metalized to serve as an electrode of the electroforming process so that a metal layer to serve as the ferrule 11 is directly formed over the outside surface of the optical fiber 10, and, as a result, a long ferrule, wherein the optical fiber 10 and the metal layer are fully integrated, is made available, whereby an optical device to constitute the desired optical fixed attenuator can be obtained by simply cutting such a long ferrule to any desired length. When the attenuation film is to be used as an attenuator 19, the attenuation film is interposed between two ferrules 11, while when the doped attenuation fiber is to be used, the doped optical fiber 10 is used to constitute a long ferrule 11 so as to be cut to any predetermined length.

### TECHNICAL FILED

The present invention relates to an optical fixed attenuator designed for adjusting the signals within the receivable range of the optical communication system and the manufacturing process thereof.

### BACKGROUND ART

The optical fixed attenuator is an optical device designed to attenuate the optical intensity to a predetermined extent and comprises an attenuator and an optical input device and an optical output device between which the attenuator is to be inserted.

The optical fixed attenuator is available in a type characterized by having an attenuation film 19a, composed of a vacuum deposition metal film or a conductive film having a large absorption coefficient and interposed between 2 units of ferrules 11, respectively containing an optical fiber 10 in the center thereof as is shown in FIG. 1, and another type characterized by a doped attenuation fiber 19b, doped with the metal and contained in the center of the ferrule 11 as is shown in FIG. 2. As seen from FIG. 1 and FIG. 2, in either of these two types, the both ends of the aligning sleeve 18, containing the ferrule 11, are provided with an interface structure for permitting the connection with the plug or the receptacle of the connector 20.

Concerning the optical fixed attenuator and the manufacturing process thereof, in the conventional manufacturing process as is shown in FIG. 9(a), the conventional ferrule 11 is characterized by that the optical fiber 10 is inserted and fixed inside the insertion hole 17 of a relatively short ferrule 11, but having a predetermined length, by using the bonding agent such as the epoxy resin bonding agent. Then as seen from (b) of the same figure, the end surface 16 is polished.

In manufacturing such a cylindrical ferrule 11, the mixture of the zirconium powder and the resin is formed into a cylinder by means of the injection molding process or by means of the extrusion die; the resultant mold is fired to remove the resin content; the diametric inside of the insertion hole 17 of the obtained cylindrical ferrule 11 is adjusted finely by using the diamond polishing compound; further, the outside of the cylindrical ferrule 11 is machined to a required roundness.

Further, as a manufacturing process of the cylindrical ferrule 11, the electroforming process as is shown in FIG. 5 has been known.

In FIG. 5, the electroforming apparatus 30 comprises an electroforming bath 31, an electroforming liquid 32, an anode 33 and a cathode 34. The numeral 35 represents a base; 36, an electrode wire material; 37, an air nozzle; 38, a supporting jig.

With such an electroforming apparatus 30, an electrodeposit of 3mm in thickness can be made to develop over the periphery of the electrode wire material when subjected to the electroforming process wherein a DC voltage is applied across the anode 33 and the cathode 34 at a current density of 4-20 A/dm2 for about a day. After the electroforming process is completed, the electrode wire 36 is pulled out of the electrodeposit, and unnecessary materials are removed by means of the extrusion or the dissolution to obtain a cylindrical electrodeposit. The obtained electrodeposit is cut to the predetermined length for use as a ferrule 11 having an insertion hole 17.

The conventional manufacturing process of the ferrule as is described above has the problems as are described in the following.

(1) The ferrule 11 has a cylindrical form, cut to a relatively short predetermined length and having an insertion hole 17 for permitting the insertion of the optical fiber 10, and needs to undergo the time-consuming processes including the process for the fine adjustment of the insertion hole 17, the process for the insertion and the bonding of the optical fiber 10, the process for polishing the end surface of the ferrule 11 with the optical fiber 10 inserted.

(2) The manufacture of the optical fixed attenuator, owing to the structure thereof, inevitably involves the processes requiring the fine and cumbersome steps such as the step for inserting the attenuation film 19a or the step for inserting the doped attenuation fiber 19b into the inside of the ferrule 11.

(3) In general, the optical fixed attenuator has a capillary length that is larger than that of the ordinary connector ferrule, and this causes the bonding and fixing of the optical fiber 10 inside the ferrule 11 to be unstable.

(4) Recently, however, with the progress of the DWDM and the Raman amplification method, a high-power transmission at the level of about 1W has become possible; as a result, the generation of the heat in the optical fiber 10 has come up as a problem to be resolved together with the problem of the deterioration of the bonding agent used for the fixing of the optical fiber 10, which adversely affect the reliability of the optical fiber. Further, there is a problem resulting from that the diathermic bonding agent is interposed between the optical fiber 10 and the ferrule 11 and that the thermal conductivity of the ferrule is lower than that of the metal, thereby causing the heat of the optical fiber 10 to be prevented from being diffused sufficiently.

(5) Even the manufacturing processing by using the electroforming process can also be encountered with the above-mentioned problems, since the manufacturing process employing the electroforming process also requires the process for incorporating the optical fiber 10 into the finished ferrule 11.

The object of the present invention is to provide an optical fixed attenuator assuring a high reliability in performance and the manufacturing process thereof designed for reducing the number of the cumbersome steps in inserting and fixing the optical fiber 10 inside the ferrule 11.

### DISCLOSURE OF THE INVENTION

The present invention relates to an optical fixed attenuator, wherein the structure and the manufacturing process of the ferrule 11 are improved while using the conventional interface structure comprising the input and output devices at the ends of the attenuator. More particularly, according to the present invention, in the beginning, a long ferrule 11 containing the optical fiber 10 is manufactured so that the optical device constituting the optical fixed attenuator can be obtained by cutting the long ferrule 11 to predetermined lengths, thereby largely reducing the number of the steps required for the insertion and fixing of the optical fiber 10 inside the ferrule 11.

Further, in the case where the attenuation film 19a is used as the attenuator 19, such attenuation film 19a is interposed between two units of the ferrules 11 which can be made available easily. In the case where the doped attenuation fiber 19b is used as an attenuator, a long ferrule 11 is formed incorporating the doped optical fiber 10 as the core material of the ferrule 11, and the long ferrule is cut to the predetermined lengths.

According to the present invention, the metalized conductive film 24 is used as one of the electrodes in the electroforming process so that the metal layer to serve as the ferrule 11 is directly formed over the outside surface of the optical fiber 10, whereby the optical fiber 10 and the metal layer are integrally formed with each other assuring a high fixing reliability without using any bonding agent.

### BRIEF DESCRIPTION OF THE DRAWINGS

FIG. 1 is a partial cutaway front view of the optical fixed attenuator as an embodiment of the present invention.

FIG. 2 is a partial cutaway front view of the optical fixed attenuator as another embodiment of the present invention.

FIG. 3 is a perspective view of a long ferrule 11 used for the optical fixed attenuator according to the present invention.

FIG. 4(a) an enlarged partial cutaway view of the optical fiber 10 whereon the ferrule 11 to be used for the optical fixed attenuator according to the present invention is developed by the electroforming process, while FIG. 4(b) is a top end view of the same.

FIG. 5 is an illustrative view of a known conventional electroforming process.

FIG. 6 is a sectional view showing the assembly process of the dual ferrule 11 according to the present invention.

FIG. 7(a) is a sectional view showing the 2 units of the ferrules 11, together with the attenuator 19, incorporated into the aligning sleeve 18 and fixed integrally with one another by the spot welding, while FIG. 7(b) is a sectional view of the ferrule 11 as being the metal layer formed over the periphery of the doped attenuation fiber 19b by the electroforming process; the doped attenuation fiber 19b is obtained by having the attenuation material doped with the dopant; the ferrule 11 is incorporated into the aligning sleeve 18 and integrated with the doped attenuation fiber 19b and the aligning sleeve 18 by the spot welding.

FIG. 8 is a view illustrating the process of axial alignment by partially cutting the portion to be cut 15 the ferrule 11 by the trimming process. FIG. 9(a) is a view illustrating a conventional ferrule 11, designed for individually having the optical fiber 10 inserted and fixed by bonding, while FIG. 9(b) is a view illustrating the process for polishing the end surface 16 of the ferrule 11 manufactured by the process given in (a).

### BEST MODE FOR CARRYING OUT THE INVENTION

The optical fixed attenuator and the manufacturing process thereof as the embodiments of the present invention will be described referring to the pertinent drawings.

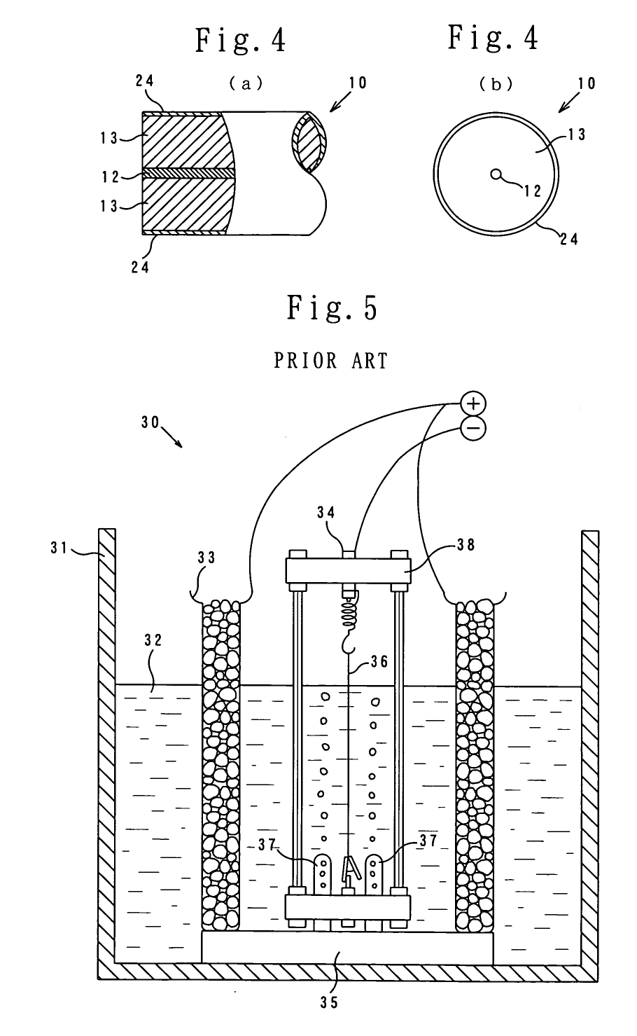

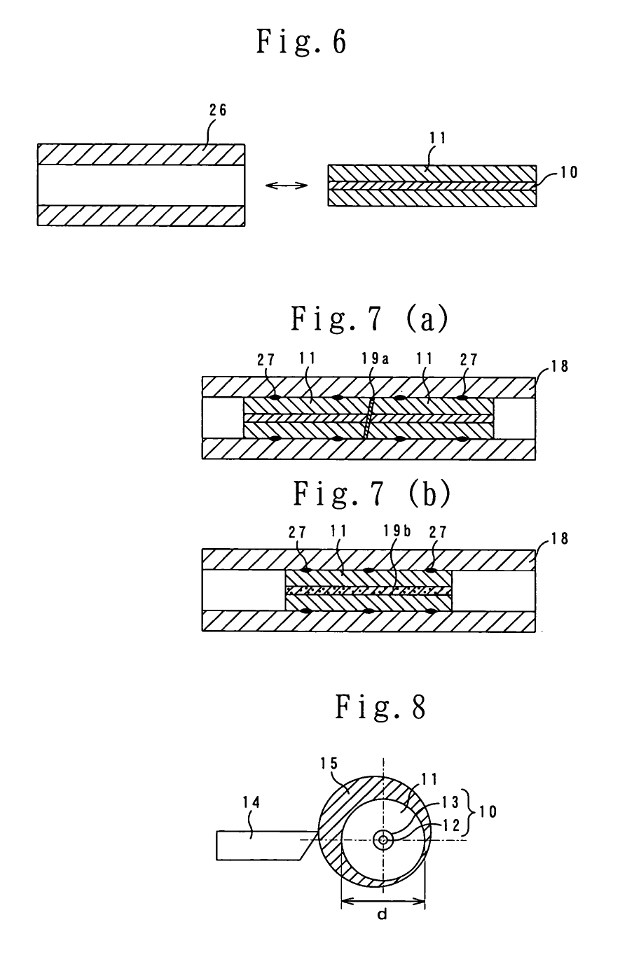

In FIG. 4, the numeral 10 represents the optical fiber to be used for the optical fixed attenuator and the manufacture thereof according to the present invention. The optical fiber 10 comprises a core 12, having a relatively high refractive index, and a clad 13, having a relatively low refractive index a normal outside diameter of 0.125 mm and the outside surface provided with a conductive film 24 for permitting the electrodeposit of a desired thickness to be formed thereon by the electroforming process such as the electroless plating process or the like.

The optical fiber 10, having the conductive film 24 formed on the outside surface thereof as described previously, is fixed to a supporting jig 38 giving a sufficient tension thereto, unlike the case given in FIG. 5, wherein the electrode wire 36 is used. Then, as described previously, a DC voltage having a current density ranging from 4 to 20 A/dm2 is applied across an anode 33 and a cathode 34 to form an electrodeposition having a predetermined diameter and a predetermined length (e.g., several tens centimeters) over the surface of the optical fiber 10 during a predetermined time period by the electroforming process. The ferrule 11 and the optical fiber 10 are bonded firmly and stably with each other through a metalized conductive film 24.

The radial runout of the outside diameter of the ferrule and that of the core 12 are required to have the mechanical accuracies equivalent to those available with the optical connector; however, the ferrule 11 of the optical connector undergoes the machining process prior to the insertion of the optical fiber 10 and thus is permitted to undergo a precision cylindrical grinding process guided by the capillary hole to assure the conventional machining accuracy, but the ferrule 11 used in the present invention is integrally formed with the optical fiber 10 and thus is not suited for the cylindrical grinding process guided by the capillary hole.

Here, the five embodiments relating to the outside diametric processing and the concentric processing for the ferrule 11 integrally incorporating the optical fiber 10 will be described below.

(1) Several processes can be considered as the processes for obtaining the ferrule 11 having a smallest possible diameter; for example, the method employing the electroforming process is useful for reducing the diameter of the ferrule 11 as much as possible. Since the outside diameters of the ferrule 11 of the presently available optical connector are mainly of 2.5 mmΦ or 1.5 mmΦ, and thus the electroforming process is employed to obtain the ferrule 11 with the outside diameter such as one severalty or 10 to 60% of the diameter of the conventional ferrule. More particularly, in the case of the electroforming process, the current density, the stirring of the core material and the electroforming liquid 32 or the like are the important factors to be controlled; however, in order to assure a satisfactory accuracy of the ferrule 11 obtained by the electroforming process, it is more effective to use the ferrule of smallest possible diameter. Further, because of the non-existence of the inter-fiber gap, the small-diameter ferrule is advantageous over the type of the ferrule 11 that requires the insertion of the optical fiber 10 into the capillary hole.

(2) In the embodiment (1), the ferrule is made to grow until a smallest possible diameter is reached by the electroforming process so that the ferrule, formed in this way, can be inserted and fixed into a concentric outer ferrule, to be formed separately when necessary, to form a dual ferrule structure having an outside diameter coinciding with the predetermined outside diameter.

As mentioned previously, the outside diameters of the ferrules 11 of the existing optical connectors range mainly from 2.5 mmΦ to 1.25 mmΦ, and thus the ferrules having such outside diameters have to be used. Thus, the ferrule, as being the small-diameter ferrule, is grown until to have a smallest possible diameter, such as about 0.5 to 0.7 mm, by the electroforming process, and such grown small-diameter ferrule 11 is then inserted and fixed into another concentric outer ferrule 26, which has been formed separately, while the radial runout of the core is set to 0.5 μm or less. By following such processes, the dependency of the outside diameter of the ferrule 11 on the electroforming process control can be reduced in obtaining the desired accuracy.

(3) In order to obtain the ferrule 11 equivalent to the outside diameter (1.25 mmΦ) of the existing ferrule 11 by the electroforming process, the diameter of the ferrule to meet such a requirement should have a diameter such as about 1.28 mm, which is a little larger than the diameter of the finished ferrule by including the allowance for finishing process. A long ferrule 11, as is shown in FIG. 3, is obtained when the electroforming process is applied; the obtained ferrule 11 is further processed until having the diameter of 1.25 mm by means of the known centerless processing and then is cut at the cutting line 25 according to the purpose of the use. A number of units of the optical fixed attenuators and the ferrules for use as the constituents such optical fixed attenuators can be obtained from a piece of a long ferrule, and thus those conforming to the concentric runout specification of the optical fiber 10 are selected for use. This method can be applied positively as long as economical in terms of the yield rate than the method wherein the processed optical fiber 10 is required to be inserted the individually into the ferrule.

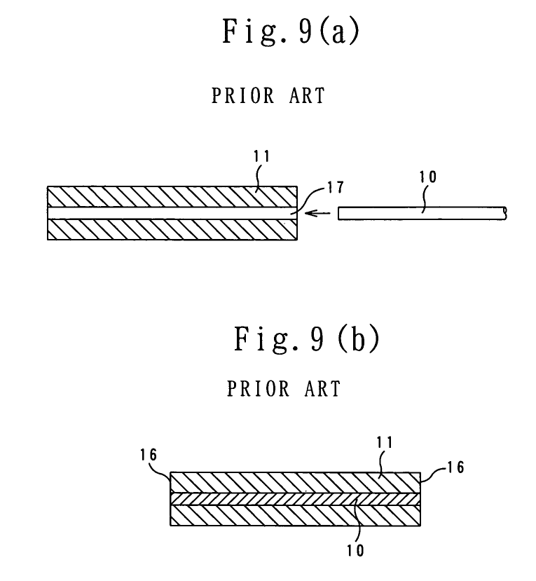

(4) The ferrule 11 is cut to a predetermined length; one end of the ferrule 11 containing the optical fiber 10 is held by the chuck of a centering cutting machine while the center of the other end thereof is set by using a precision microscope; the portion 15, subject to the grinding process, of the optical fiber 10 is cut for alignment with a cutter 14 centering around the core 12 of the optical fiber 10 by the peripheral trimming process as is shown in FIG. 8.

(5) In the embodiment (3), after selecting the optical fiber according to the specifications in the initial stage of processing, those conforming to the specifications undergo the outside diameter finishing process by the centerless processing, while the nonconforming pieces may be subjected to the cutting process for trimming the peripheral portions thereof.

The ferrule 11, which has been formed and cut to a predetermined length as described previously, is contained, together with the attenuator 19, in the aligning sleeve 18 to form the optical fixed attenuator.

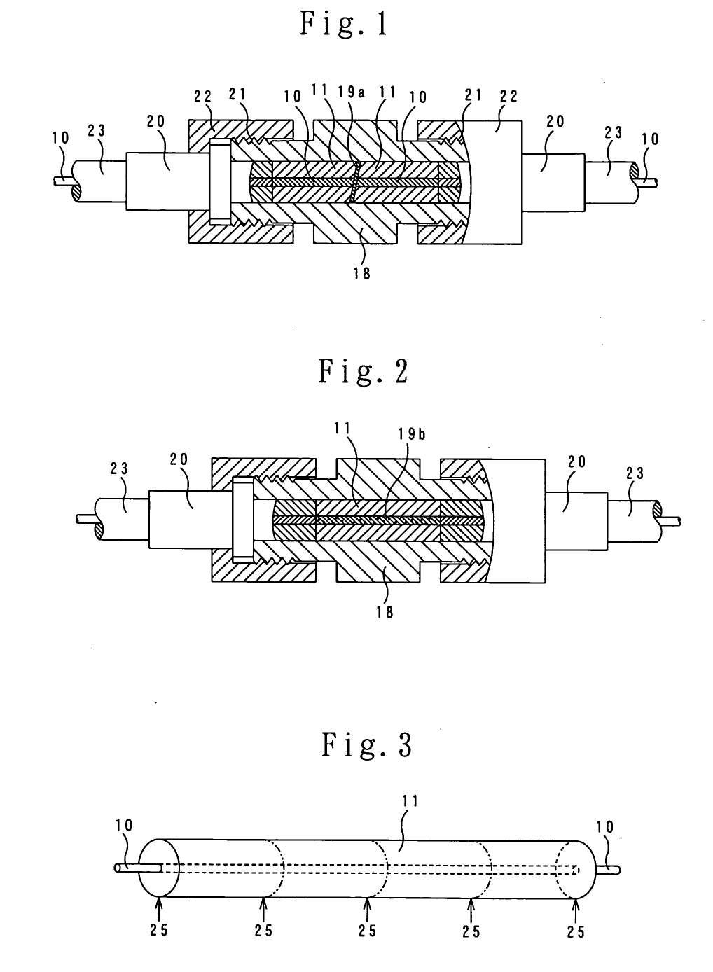

As mentioned previously, the optical fixed attenuator comes in a type wherein an attenuation film 19a, formed with a vacuum-deposition metal film or a conductive film having a high absorption coefficient, is interposed between the 2 pieces of the ferrules 11, each containing a piece of centering optical fiber 10, as is shown in FIG. 1 and another type wherein an attenuation dope fiber 19a, made of an optical fiber doped with the metal, is provided in the center of the ferrule 11.

In the embodiment shown in FIG. 1, an attenuation film 19a interposed between the two pieces of ferrules 11 are inserted, integrally with the two pieces of the ferrules 11, into the through hole passing the center of the aligning sleeve 18. This attenuation film 19a is normally placed at an angle, necessary for avoiding undesired reflection, to the plane vertical to the optical axis. The attenuation film 19a, having a diameter equal to or a little less than the diameter of the ferrule 11, is formed and is either interposed between the 2 pieces of the ferrules 11 or provided on one end surface of any one of the two pieces of the ferrules 11 by means of the vacuum deposition process so as to butt with one end surface of the other ferrule 11 not provided with the attenuation film 19a.

In the embodiment wherein the attenuation film 19a is interposed between the 2 pieces of the ferrule 11, either one of two ways, namely, one way wherein the two ferrules 11 are forced to come closely in contact with each other through the interposed attenuation film 19a or the other way wherein the two pieces of the ferrules 11 are joined with each other through the matching member for preventing the stress from acting on the attenuation film 19a. As shown in FIG. 7(a), the 2 pieces of the ferrule 11 are integrally fixed to the aligning sleeve 18 by being welded thereto at several points by means of the spot welding by using the YAG laser or the like. Fixing the ferrules 11 by means of the spot welding characterizes that the ferrule 11 is a metal ferrule formed by the electroforming process.

Further, as shown in FIG. 1, the outer end portions of the aligning sleeve 18 are provided with the threads 21 respectively so that these threaded end portions, when driven into the nuts 22, enable each of the connectors 20 of the optical fiber cable 23 to be connected by abutting the end surface of the ferrule 11. Needless to say, the connection method described here is not only connection method applicable in the present invention but other known connection methods such as the one using the receptacle, the one using the plug and others are also applicable to the present invention.

In the embodiment given in FIG. 2, the doped attenuation fiber 19b is used as the attenuator 19 and designed for insertion inside the adjusting sleeve 18 by using only one piece of ferrule 11 having a specified attenuation. The doped attenuation fiber 19b comprises an optical fiber 10, whose core 12 is doped with the cobalt or the like, to obtain a desired attenuation.

The ferrule 11 in the present embodiment is also integrally fixed to the aligning sleeve 18 by means of the spot welding by using the YAG laser or the like applied to a plurality of spots, given as weld spot 27, in FIG. 7(b). Further, as shown in FIG. 2, the threads 21 are provided with the outsides of the both ends of the aligning sleeve 18 so that the connectors 20 of the optical fiber cable 23 can be made to respectively abut the both end surfaces of the ferrule 11 by driving the clamping nuts 22 along the threads, and this method is not limited to any specific embodiment as mentioned previously too.

Since the present invention is composed as described in the foregoing, the ferrule 11, capable of securely fixing the optical fiber 10, can be obtained by simply cutting a long ferrule obtained by the electroforming process to any desired length. Thus, the conventional cumbersome manufacturing processes involving the insertion of the optical fiber 10 into the individual ferrules 11 and the following bonding and fixing processes can be reduced largely to provide a manufacturing process of the optical fixed attenuators at low cost.

The conventional manufacturing process of the optical fixed attenuator involved fine and cumbersome processes such as those for inserting the attenuation film 19a and the doped attenuation fiber 19b into inside the ferrule 11; however, according to the present invention, the manufacturing process of the optical fixed attenuator can be simplified by employing the process wherein the attenuator 19, comprising an attenuation film 19a directly formed on the end surface of an independent or one of the ferrules 11, is interposed between the two finished pieces of the ferrules 11 and inserted to be fixed inside the aligning sleeve 18, or by employing the process wherein the ferrule 11 is formed as a metal layer obtained by subjecting the core thereof, previously made into a doped attenuation fiber 19 by being doped with the attenuation agent, to the electroforming process.

In general, in the conventional optical fixed attenuator, the bonding and fixing condition of the optical fiber inside the ferrule 11 is unstable owing to that the capillary length of larger than that of the ordinary connector ferrule; however, according to the present invention, the ferrule 11 itself is electroformed so that the optical fiber 10 is integrally formed with the metal layer to provide the ferrule 11 wherein the optical fiber 10 can be fixed extremely stably.

The bonding agent not being used, a high reliability can be maintained for the optical fixed attenuator even during the high-power transmission even when the heat is produced owing to the heat occurring inside the ferrule 11. Further, since the optical fiber 10 is integrally formed with the metal ferrule 11 without having any interposed materials such as the heat insulating bonding agent, even when the heat is produced by the optical fiber 10 during the high-power transmission, the heat from the optical fiber 10 is diffused outside quickly through the ferrule 11.

For the processes involving the outside diameter and the concentricity the ferrule 11, the conventional processes are applicable, and thus there is little possibility of being encountered with new problems.

1. An optical fixed attenuator, comprising a ferrule, whose periphery is a metal layer formed over an optical fiber 10, whose periphery is a conductive film 24 previously metalized by the electroforming process, wherein the ferrule 11 is cut to a predetermined length and contained and fixed, together with an attenuator 19, inside the aligning sleeve 18.

2. The optical fixed attenuator as defined in claim 1, wherein an attenuator 19, comprising an attenuation film 19a, in a form of thin film, directly formed on the end surface of an independent or one of the ferrules 11, is interposed between the two ferrules 11, and is contained and fixed inside the aligning sleeve 18.

3. The optical fixed attenuator as defined in claim 1, wherein the ferrule 11 whose periphery is provided with a metal layer formed by subjecting the doped attenuation fiber 19b, obtained by doping the internal core 12 with the doping agent, to the electroforming process.

4. The optical fixed attenuator as defined in claim 1, wherein a small-diameter ferrule 11 having the metal layer formed therewith to provide the ferrule whose outside diameter becomes 10 to 60% of the outside diameter or the ordinary ferrule.

5. The optical fixed attenuator as defined in claim 4, wherein the small-diameter ferrule 11 is inserted and fixed inside another concentric outer ferrule 26 to provide a ferrule having a dual structure and a predetermined outside diameter.

6. An optical fixed attenuator manufacturing process, comprising a metalizing process for forming a conductive film 24 over the outside surface of the optical fiber 10, a ferrule forming process for letting a metal layer develop over the periphery of the optical fiber having the conductive film 24 formed by the metalizing process, a process for cutting the ferrule 11 to a predetermined length, a process comprising the operation for having one end of a cut ferrule 11 held by a chuck of a cutting machine, the operation for having the other end the ferrule 11 undergo the outside diameter finishing operation, comprising the centering operation by using a precision microscope and the subsequent periphery trimming operation for the portion to be cut 15 while maintaining a desired concentricity, and a process for having the ferrule 11, which has undergone the outside diameter finishing process, inserted and fixed inside the aligning sleeve 18.

7. An optical fixed attenuator manufacturing process, comprising a process for having the outside surface of the optical fiber 10 metalized to form a conductive film 24, a process for having the ferrule 11 formed by letting a metal layer develop over the periphery of the optical fiber 10 having a metalized conductive film 24, a process for cutting the ferrule 11 to a predetermined length, a process of the outside diameter finishing operation of the cut ferrule 11 by the centerless machining operation, and a process for containing and fixing the ferrule 11, which has undergone the centerless machining operation, in the aligning sleeve 18, together with the attenuator 19.

8. The optical fixed attenuator manufacturing process as defined in claim 7, comprising a process for selecting those ferrules 11 whose radial runouts are conforming to the specification from among the ferrules 11 which have undergone the centerless machining operation, and a process for having the selected ferrule 11, together with the attenuator 19, contained and fixed inside the aligning sleeve 18.

9. The optical fixed attenuator manufacturing process as defined in claim 7, comprising a process for discriminating the non-conforming ferrules 11 from among those ferrules which have undergone the centerless machining, a process for applying the outside diameter finishing operation for one end of the non-conforming ferrules 11 by trimming the periphery thereof according to the centering by the precision microscope while the other end of the non-conforming ferrule 11 is held with the chuck of the cutting machine, and a process for having the ferrule 11, which has undergone the outside diameter finishing operation, contained and fixed in side the aligning sleeve 18 together with the attenuator 19.

10. The optical fixed attenuator manufacturing process as defined in claim 6, 7, 8 or 9, wherein the process for having the ferrule 11 and the attenuator 19 contained and fixed together inside the aligning sleeve 18 is characterized by be being integrally fixed together by applying the spot welding to a plurality of spots.
